(19) United States
(12) Patent Application Publication
(10) Pub. No.: US 2019/0340546 A1
(43) Pub. Date: Nov. 7, 2019

(54) REAL TIME PERSONAL MOBILITY PLANNER SYSTEM

(71) Applicant: GM GLOBAL TECHNOLOGY OPERATIONS LLC, Detroit, MI (US)

(72) Inventors: Claudia V. Goldman-Shenhar, Mevasseret Zion (IL); Gila Kamhi, Zichron Yaakov (IL)

(73) Assignee: GM GLOBAL TECHNOLOGY OPERATIONS LLC, Detroit, MI (US)

(21) Appl. No.: 15/967,865

(22) Filed: May 1, 2018

(51) Int. Cl. G06Q 10/04; G06Q 10/02

(52) U.S. Cl. CPC G06Q 10/047; G06Q 10/02

(57) ABSTRACT

A mobility planning server is disclosed that is configured to: receive a listing of one or more scheduled activities for a plurality of users; identify a plurality of different types of mobility modes potentially available to transport the users; retrieve, from one or more service providers of the mobility modes, the potential availability of the mobility modes provided by the service provider and any service provider indicated constraints regarding the mobility modes; analyze the one or more scheduled activities, identified mobility modes, the potential availability of the mobility modes, and constraints indicated by any service provider; prepare a mobility plan for each user based on the analysis wherein the mobility plans include a mobility planning server selected mobility mode for each activity; confirm the availability of mobility modes included in the mobility plans; confirm user acceptance of the mobility plans; and schedule a selected mobility mode for each activity.

### TECHNICAL FIELD

The present disclosure generally relates to scheduling applications, and more particularly relates to systems and methods for scheduling transportation services and delivery services for multiple users with multiple service providers.

### BACKGROUND

New mobility modes are becoming available in various locales. Instead of being relegated to using a taxi, public transportation, or a privately-owned vehicle to get around, an individual in certain locales may have other mobility modes available such as a rental vehicle (e.g., Avis), a shared car driven by the user (e.g., MAVEN), a shared car not driven by the user (e.g., Lyft, Uber), an autonomous vehicle, a shared autonomous vehicle, or an e-bike/bike, among others. Each of these mobility modes may have its own proprietary method for scheduling the use of the mobility mode.

With the proliferation of smartphones and the like, busy individuals are more likely to maintain an electronic calendar instead of solely a paper calendar for keeping track of their activities. Scheduling transport to the various activities identified in one's calendar can be a time-consuming process, particularly if different mobility modes are selected for transport to different events.

Accordingly, it is desirable to provide systems and methods for retrieving scheduled activities from a user's calendar and automatically scheduling appropriate mobility modes for transport to the different activities. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for retrieving scheduled activities from a user's calendar and automatically scheduling appropriate mobility modes for transport to the different activities. In one embodiment, a processor-implemented method of mobility planning is disclosed. The method includes receiving, by a processor in a server over a public network, a listing of one or more scheduled activities over a predefined period of time for each of a plurality of users; identifying, by the processor, a plurality of different types of mobility modes potentially available to transport the users to the one or more scheduled activities; and analyzing, by the processor, the listing of the one or more scheduled activities, a listing of the potentially available mobility modes, preferences or constraints for one or more of the users, and constraints indicated by one or more service providers. The method further includes preparing, by the processor, a mobility plan for each user based on the analysis, wherein the mobility plans include a processor selected mobility mode for each activity requiring user transport to the activity; confirming, by the processor, the availability of mobility modes included in the mobility plans; confirming user acceptance of the mobility plans; and scheduling a selected mobility mode for each activity requiring user transport to the activity.

In one embodiment, the mobility modes include one or more of walking, a private car, a rental vehicle, a shared car driven by the user, a shared car not driven by the user, an autonomous vehicle, a shared autonomous vehicle, a bike, a taxi, and public transportation.

In one embodiment, receiving the listing of one or more scheduled activities for a user includes: receiving a mobility plan request via a user device; receiving, from the user device, a listing of one or more scheduled activities spanning a time frame that is consistent with a time frame specified in the plan request; retrieving, from the listing for each activity requiring user transport or delivery, one or more of the time of the activity, the flexibility of time for the activity, and the duration of the activity; retrieving, from the listing for each activity requiring user transport or delivery, the pickup address and drop off address; and retrieving, from the listing for each activity requiring user transport or delivery, the preferred mode of mobility or other preferences if provided in the listing.

In one embodiment, confirming the availability of mobility modes included in the mobility plan includes sending, for each activity requiring user transport to the activity, a proposed route to a selected mobility mode or service provider for the selected mobility mode.

In one embodiment, the method further includes sending, for each activity requiring user transport to the activity, a proposed route to a non-selected mobility mode or service provider for the non-selected mobility mode.

In one embodiment, confirming user acceptance of the mobility plan includes receiving user confirmation of the selected mobility mode.

In one embodiment, confirming user acceptance of the mobility plan includes receiving user selection of a non-selected mobility mode and updating the mobility plan to include the user selected mobility mode.

In one embodiment, scheduling a selected mobility mode includes notifying a mobility mode service provider that a mobility mode is in route to a user.

In one embodiment, the method further includes receiving traffic information from a mobility mode service provider or from a traffic service provider.

In one embodiment, the method further includes receiving from a mobility mode or mobility mode service provider one or more of availability, location, and time of arrival of the mobility mode.

In another embodiment, a mobility planning server including one or more processors configured by programming constructions encoded on non-transient computer readable media is disclosed. The mobility planning server is configured to: receive, over a public network, a listing of one or more scheduled activities for each of a plurality of users; identify a plurality of different types of mobility modes potentially available to transport the users to the one or more scheduled activities; retrieve, over a public network from one or more service providers of the mobility modes, the potential availability of the mobility modes provided by the service provider and any service provider indicated constraints regarding the mobility modes; and analyze the listing of the one or more scheduled activities, a listing of identified mobility modes, the potential availability of the mobility modes provided by service providers, preferences or constraints for one or more of the users, and constraints indicated by one or more service providers. The mobility planning server is further configured to prepare a mobility plan for each user based on the analysis, wherein the mobility plans include a mobility planning server selected mobility mode for each activity requiring user transport to the activity; confirm the availability of mobility modes included in the mobility plans; confirm user acceptance of the mobility plans; schedule a selected mobility mode for each activity requiring user transport to the activity; and update, delete, or change a mobility plan when one or more conditions change.

In one embodiment, the mobility planning server is further configured to: retrieve, from the listing for each activity requiring user transport or delivery, one or more of the time of the activity, the flexibility of time for the activity, and the duration of the activity; retrieve, from the listing for each activity requiring user transport or delivery, the drop off address; deduce, for each activity requiring user transport or delivery when a pickup address is not provided in the listing, the pickup address from user location information; and retrieve, from the listing for each activity requiring user transport or delivery, the preferred mode of mobility or other preferences if provided in the listing.

In one embodiment, the mobility planning server is further configured to receive user selection of a non-selected mobility mode and update the mobility plan to include the user selected mobility mode.

In another embodiment, a mobility planning system includes a mobility planning server and a mobility planning client module. The mobility planning server includes one or more processors configured by programming constructions encoded on non-transient computer readable media. The mobility mapping server is configured to: receive, over a public network, a mobility plan request and a listing of a plurality of scheduled activities for each of a plurality of users, wherein the listing includes a plurality of scheduled activities requiring user transport to the activity; select a mobility mode for each activity requiring user transport to the activity, wherein a plurality of the selected mobility modes are of different types and from different service providers; prepare a mobility plan for each user that includes the selected mobility modes; and schedule a selected mobility mode for each activity requiring user transport to the activity. The mobility planning client module includes one or more processors on a user device configured by programming instructions encoded on non-transient computer readable media. The mobility planning client module is configured to: send, over the public network, a mobility plan request and a listing of a plurality of scheduled activities for its user to the mobility planning server; and receive, over the public network, a prepared mobility plan for its user that includes the selected mobility modes from the mobility planning server.

In one embodiment, the mobility planning client module is further configured to upload calendar entries from a calendar application accessible via the user device to the mobility planning client module and wherein the listing of a plurality of scheduled activities for its user the mobility planning client module is configured to send to the mobility planning server includes the uploaded calendar entries.

In one embodiment, the mobility planning client module is further configured to synchronize calendar entries for a predefined time period from the calendar application accessible via the user device with the calendar entries uploaded to the mobility planning client module.

In one embodiment, the mobility planning client module is further configured to provide a user interface for allowing the uploaded calendar entries to be edited.

In one embodiment, the user interface includes a graphical user interface that is configured to provide for the use of vehicle mobility icons to indicate a mobility mode preference for a calendar entry activity.

In one embodiment, the mobility mapping server is further configured to: identify a plurality of different types of mobility modes potentially available to transport the user to the one or more scheduled activities; retrieve, over a public network from one or more service providers of the mobility modes, the potential availability of the mobility modes provided by the service provider and any service provider indicated constraints regarding the mobility modes; analyze the listing of the one or more scheduled activities, a listing of the identified mobility modes, the potential availability of the mobility modes provided by service providers, and any service provider indicated constraints; and prepare the mobility plan for the user based on the analysis.

In one embodiment, the mobility mapping server is further configured to confirm the availability of the mobility modes included in the mobility plan and confirm user acceptance of the mobility plan.

### DESCRIPTION OF THE DRAWINGS

The exemplary embodiments will hereinafter be described in conjunction with the following drawing figures, wherein like numerals denote like elements, and wherein:

FIG. 1 is a block diagram depicting an example operating environment in which a mobility planning system may be implemented, in accordance with various embodiments;

FIG. 2 is a block diagram depicting an example mobility planning system, in accordance with various embodiments; and

FIG. 3 is a process flow chart depicting an example process in an example mobility planning system for scheduling transportation for users and/or deliveries, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

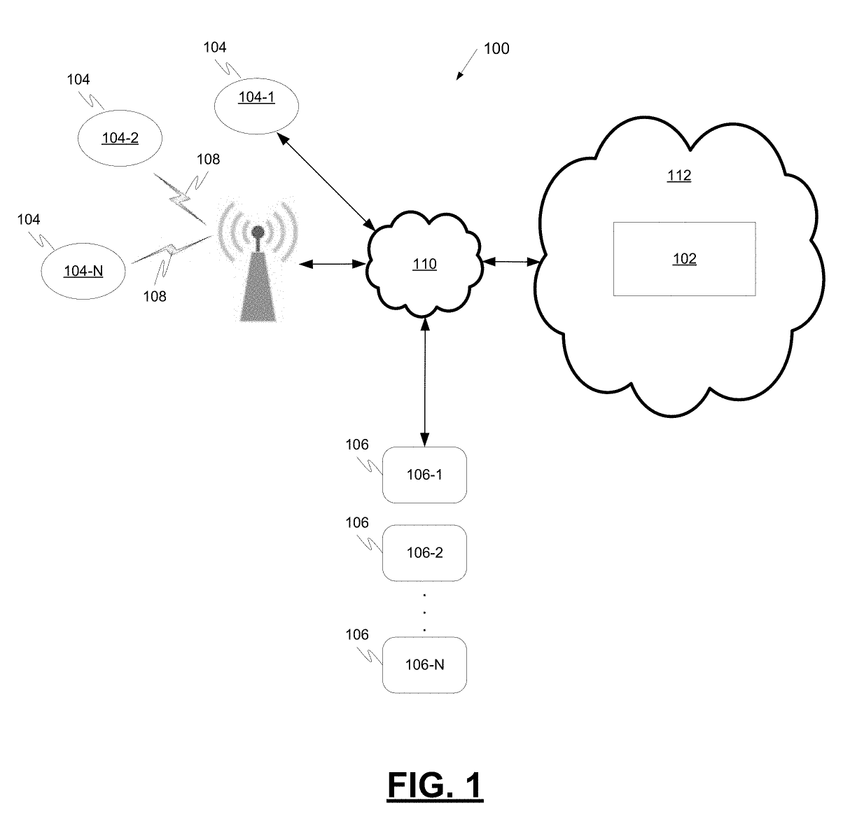

FIG. 1 is a block diagram depicting an example operating environment 100 in which a mobility planning system 102 may be implemented. The example mobility planning system 102 is configured to schedule mobility modes (e.g., walking, automobile, bike) for transporting users to different activities indicated by the users' calendars. In one embodiment, the mobility planning system 102 is configured to schedule the mobility modes through retrieving the schedule of multiple users, retrieving data on mobility resources available from mobility vehicle service providers, and based on user preferences and service provider preferences develop a mobility plan for each of the users. In one embodiment, the mobility planning system 102 is configured to allocate a riding solution from one of many mobility modes to each user (out of a dynamic set of users) in real time while optimizing the riding solutions across different criteria such as minimizing riding distances, riding times, riding costs, leaving as much time free in a block as possible, maximizing users' preference fulfillment, maximizing user satisfaction, minimizing battery consumption, and others. In one embodiment, the mobility planning system 102 is configured to optimize, in real time, (1) the suggested mobility modes to better accommodate a user's schedule and (2) the suggested mobility modes to better allocate resources based on user and mobility mode (e.g., vehicle) location, time constraints, features of the specific modes, charging needs and personal preferences. In one embodiment, the mobility planning system 102 is configured to create a shared mobility space where multiple service providers can be made available to users and the riding solutions suggested to users by the mobility planning system 102 are optimized across the constraints of different service providers. Constraints may include time constraints, location constraints, road type constraints, charging station constraints, and other types of constraints. In one embodiment, the mobility planning system 102 is configured as an automated optimization solution that can improve the mobility of users.

The example operating environment 100 includes a plurality of user devices 104 for use by users who desire to use the mobility planning system 102 to schedule their transportation for a period of time (e.g., for the day or for the week) and/or to schedule a delivery during the period of time. The example operating environment 100 also includes a plurality of mobility modes 106 that can be scheduled by the mobility planning system 102 for use in transporting users and/or deliveries of goods or third-party people.

A user device 104 supported by the operating environment 100 may be implemented using any suitable hardware platform. In this regard, the user device 100 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 104 supported by the operating environment 100 is realized as a computer-implemented or computer-based device having the hardware, software, firmware, and/or processing logic needed to carry out the various techniques and methodologies described herein.

For example, the user device 104 includes a microprocessor in the form of a programmable device that includes one or more instructions stored in an internal memory structure and applied to receive binary input to create binary output. In some embodiments, the user device 104 includes cellular communications functionality such that the device carries out voice and/or data communications 108 over a communication network using one or more cellular communications protocols. In various embodiments, the user device 104 includes a visual display, such as a touch-screen graphical display, or other display.

The mobility modes supported by the example operating environment 100 include, but are not limited to, walking, a private car, a rental vehicle (e.g., Avis), a shared car driven by the user (e.g., MAVEN), a shared car not driven by the user (e.g., Lyft, Uber), an autonomous vehicle, a shared autonomous vehicle, an e-bike/bike, a taxi, and public transportation.

In addition to scheduling mobility modes for the transport of users, the example mobility planning system 102 is configured to schedule mobility modes for delivery transport in connection with user transportation (e.g., vehicle that transports the delivery can further transport the user to the next destination) or in parallel with user activity or transportation. Deliveries can be for goods (e.g., courier) or for third-party people (e.g., transporting nanny to pick up user's kids from school and deliver them to user's home, while user is at the office).

The user devices 104 and mobility modes 106 (and/or mobility mode service providers) may communicate with the example mobility planning system 102, for example, via a cellular communication channel 108 over a cellular network such as 4G LTE or 4G LTE-V2X, a public network 110, and/or a private network 112. The example user devices 104 include a module (not shown) for communicating with the example mobility planning system 102.

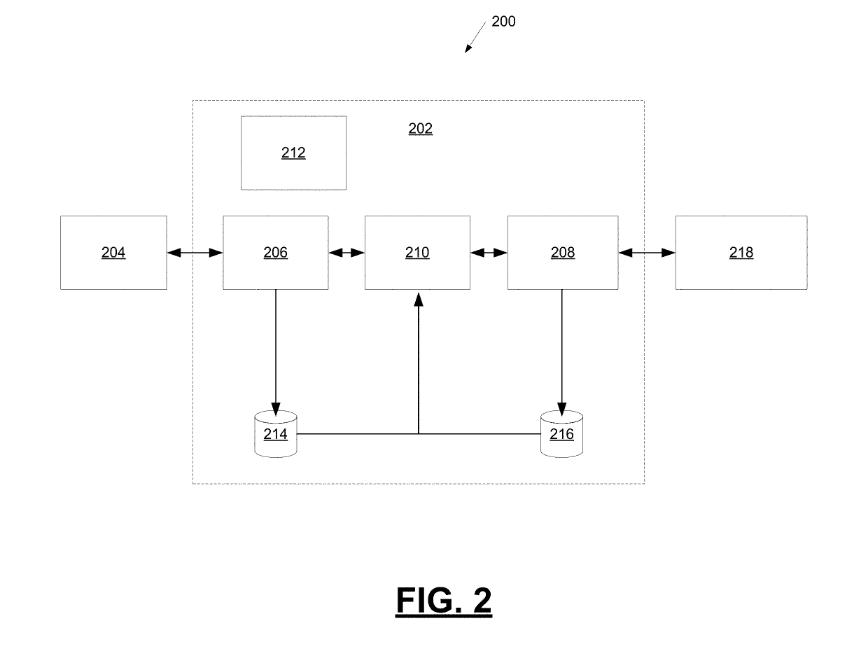

FIG. 2 is a block diagram depicting an example mobility planning system 200. The example planning system includes a mobility planning server 202 and a client module 204 that operates in connection with a user device. The example mobility planning server 202 comprises one or more processors configured by programming instructions encoded on non-transient computer readable media.

The processor may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the mobility planning server 202, a semiconductor-based microprocessor (in the form of a microchip or chip set), any combination thereof, or generally any device for executing instructions. The computer readable media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the mobility planning server 202. The instructions may include one or more separate programs, each of which comprises an ordered listing of executable instructions for implementing logical functions.

The example mobility planning server 202 is configured to receive a request from one or more client modules 204 executing on user devices to schedule transportation, retrieve user calendar entries, retrieve mobility mode availability, prepare a mobility plan for each user, confirm mobility mode availability for mobility plan(s), confirm user(s) acceptance of mobility plan(s), and execute mobility plan(s). The example mobility planning server 202 includes a user interface module 206, a service provider interface module 208, a scheduling module 210, and a data mining module 212. The user interface module 206, service provider interface module 208, a scheduling module 210, and data mining module 212 are implemented, in this example, via the one or more processors configured by programming instructions.

The example user interface module 206 is configured to interface with the client module 204, for example, via a public network such as the Internet. The example user interface module 206 is configured to receive a mobility plan request from a user via the client module 204, identify the user associated with the mobility plan request, retrieve a user profile, which may include user preferences, from a user profile datastore 214, and receive a listing of one or more scheduled activities for the user over a predefined period of time. The predefined period of time may be specified in the mobility plan request, and/or may have a duration equal to a portion of a day, an entire day, a week, or some other predefined period of time.

The listing of one or more scheduled activities may be retrieved directly from the client module 204 or may be retrieved from a calendar service accessible over a public network (e.g., Google Calendar). The listing of one or more scheduled activities may include, for each activity, one or more of the time of the activity, the flexibility of time for the activity, and the duration of the activity. The listing of one or more scheduled activities may include, for each activity, a pickup address for the user and a drop off address for the user. In some examples, the pickup address may not be explicitly provided but instead deduced from the user's location around the pickup time. The listing of one or more scheduled activities may include, for each activity, a preferred mode of mobility or other preferences provided by the user. The listing of one or more scheduled activities may, for each activity, identify whether the scheduled activity involves a delivery (e.g., delivery of goods or delivery of a third-party person) or a ride (e.g., user transport to the activity).

The example user interface module 206 is configured to send the listing of one or more scheduled activities and any user preference information to the scheduling module 210 for the generation of a mobility plan for the user, retrieve the generated mobility plan from the scheduling module 210, and confirm user acceptance of the mobility plan. Confirming user acceptance of the mobility plan may include receiving user confirmation of the selected mobility mode (e.g., vehicle or walking), receiving user selection of a non-selected mobility mode, and/or updating the mobility plan to include the user selected mobility mode.

The example user interface module 206 may be configured to track the user's preferences and decisions, learn over time (e.g., using machine learning techniques) to suggest more desirable solutions for the user, and to store the preferences in the user profile datastore 214.

As an example of the type of preferences that may be learned and stored, the example mobility planning server 202 may learn to prioritize a first user, when traffic patterns change and the time is late night, for a bike as a mobility mode over a second user who bikes only during weekends or a third user who has never biked and never shared a mobility mode.

In another example, the example mobility planning server 202 may learn that a fourth user's preference for sharing is dependent on a tradeoff between time and cost. The example mobility planning server 202 may learn, for example, that if the use of a shared vehicle saves at least 10 minutes and costs less than $5, the fourth user may be willing to accept a shared vehicle as a mobility mode.

The example service provider interface module 208 is configured to interface with one or more service providers 218, for example, via a public network such as the Internet. The example service provider interface module 208 is configured to create a listing of the mobility modes potentially available to transport the user to the one or more scheduled activities and store the listing in a service provider database 216. The mobility modes may include one or more of walking, a private car, a rental vehicle (e.g., Avis), a shared car driven by the user (e.g., MAVEN), a shared car not driven by the user (e.g., Lyft, Uber), an autonomous vehicle, a shared autonomous vehicle, an e-bike/bike, a taxi, and public transportation.

The example service provider interface module 208 is further configured to retrieve the potential availability (e.g., times generally available, specific availability periodically reported, location, and/or geographical area of operation) of the mobility modes provided by service providers and any service provider indicated constraints regarding the mobility modes, store this information in a service provider database 216, and provide the potentially available mobile modes and any service provider indicated constraints regarding the mobility modes to the scheduling module. The potential availability and the constraints may be retrieved over a public network from one or more service providers of the mobility modes in real time or from the datastore 216.

The example service provider interface module 208 is configured to confirm the availability of mobility modes included in a mobility plan, after the scheduling module determines the mobility plan. Confirming the availability of mobility modes included in the mobility plan may include sending, for each activity requiring user transport to the activity, a proposed route to a selected mobility mode (or service provider for the selected mobility mode) for confirmation by the selected mobility mode (or service provider) that the selected mobility mode is available for the proposed route. Confirming the availability of mobility modes included in the mobility plan may include receiving from the mobility mode (or mobility mode service provider) one or more of availability, location, and time of arrival of the mobility mode.

The example service provider interface module 208 may also be configured to confirm the availability of non-selected mobility modes (e.g., to facilitate user selection of a different mobility mode) in some scenarios. Confirming the availability of a non-selected mobility mode may include sending, for each activity requiring user transport to the activity, a proposed route to a non-selected mobility mode (or service provider for the non-selected mobility mode).

The example service provider interface module 208 is also configured to schedule a user agreed-to mobility mode for each activity requiring user transport to the activity. Scheduling an agreed-to mobility mode may include notifying a mobility mode service provider that a mobility mode is in route to user. Scheduling an agreed-to mobility mode may also include receiving traffic information from the mobility mode (or mobility mode service provider) or from a traffic service provider.

The example scheduling module 208 is configured to analyze the listing of the one or more scheduled activities for each user requesting a mobility plan, a listing of potentially available mobility modes, the potential availability of the mobility modes provided by service providers, and constraints indicated by service provider and prepare a mobility plan for each user with a mobility plan request based on the analysis, wherein the mobility plan includes the selection of a mobility mode for each activity requiring user transport to the activity. The example scheduling module 208 may implement an algorithm that is configured to implement a job-shop scheduling or solve a job-shop problem (JSP) when determining a mobility plan.

Analyzing may involve calculating a “best” route based on activity requirements and user preferences. The scheduled activity may involve a delivery (goods or a third-party person) in parallel with user activity and analyzing may involve calculating a “best” route for the delivery based on delivery requirements and user preferences. The scheduled activity may involve a delivery (goods or a third-party person) in series with user activity and analyzing may involve calculating a “best” route for the delivery based on delivery requirements, user activity requirements, and user preferences.

The example scheduling module 208 is also configured to modify a mobility plan when it is determined that a route change is needed, such as when a user requests a route change, traffic conditions necessitate a route change, a problem with a selected mobility mode necessitates a route change, a time change for an activity necessitates a route change, or other conditions necessitate a route change. The new route may be sent to a selected mobility mode via the service provider interface module 208 and a notification of the new route in the mobility plan may be sent to the user via the client interface module 206.

The example scheduling module 208 may be configured to calculate the solution of routes for one user using one vehicle using the user's constraints for a predetermined period of time (e.g. one full day or one full week). In some embodiments, the example scheduling module 208 can be configured to optimize only the time to leave based on expected arrival times of some of the possible mobility modes and the user would choose the mobility mode for user transport. In such a case, the mobility planning server 202 would keep track of the user's location and the time of day to allow the mobility planning server 202 to update planned ride options including the time to leave for the various ride options. In some embodiments, the example scheduling module 208 can be configured to send requests for vehicles based on a user's needs and constraints and a fleet manager can optimize which vehicle to send and what route it takes based on a separate optimization algorithm available to the fleet manager. In some embodiments, the example scheduling module 208 can be configured to send requests for vehicles based on a user's needs and constraints and a fleet of fleets manager can optimize which vehicle to send and what route it takes based on a separate optimization algorithm that optimizes the management of the fleet of fleets. In some embodiments, the example scheduling module 208 can be configured to prepare a mobility plan when an activity does not have a predetermined pickup or drop off location. In this scenario, locations can be set in real time at the user's present location and the example scheduling module 208 can adjust its solution based on this real-time information. In some embodiments, the example scheduling module 208 can be configured to update, delete, or change a mobility plan when one or more conditions change (e.g., input by a user, or deduced by the example scheduling module 208 based on conditions such as increase in traffic, user does not exit a meeting, user is delayed for a time, and others

The example data mining module 212 is configured to monitor various modules in the mobility planning server 202, including the client interface module 206 and the scheduling module 210, to collect user calendar events and preferences. This data can be analyzed (e.g., using social data analytics) and can be used to improve the optimization process used by service providers and businesses that may be interested in acquiring customers.

The example mobility client module 204 is configured to interface with the client interface module 206 to request and to receive a mobility plan. The example mobility client module 204 is configured to provide a user interface for use by a user to request, review, and approve a mobility plan. The mobility client module 204 may operate using an application program executing on a user device and/or via a web browser executing on a user device.

The mobility client module 204 is configured to upload calendar entries for a predefined time-period from a calendar application accessible via the user device to the mobility client module 204. The mobility client module is also configured to synchronize calendar entries for a predefined time-period from the calendar application accessible via the user device with the calendar entries uploaded to the mobility client module 204. The mobility client module 204 is further configured to send the calendar entries to the mobility planning server 202 and to provide a user interface for allowing the calendar entries to be edited.

The example user interface may be configured to allow to be edited, for each calendar entry activity, the time, pickup address, drop off address, type of activity (e.g., delivery or user transport), duration, time flexibility, comments, preferences for mobility mode for the activity, preferred points of interest (POIs), and/or preferred contacts. The user interface may include a graphical user interface, a speech interface, a touch interface and/or a haptic interface in a user device. When a graphical user interface is provided, the user interface may be configured to provide for the use of vehicle mobility icons to indicate a mobility mode preference for a calendar entry activity.

The mobility client module 204 may be further configured to send the vehicle mobility icon associated with a calendar entry activity to the server along with the calendar entries. The mobility client module may be further configured to request a mobility plan for a user's calendar entries. The mobility client module 204 may be further configured to allow a user to change user preferences. The mobility client module 204 may be further configured to allow a user to review upcoming ride(s). The mobility client module 204 may be configured to allow a user to review system explanations and notifications. The mobility client module 204 may be further configured to allow a user to change events (e.g., edit, delete, create events).

The example mobility client module 204 may include a graphical user interface (GUI) that is configured to allow a user to upload a calendar to the client module 204; sync a user's calendar with the calendar uploaded to the client module 204; send the calendar to the mobility server 202; edit any of the entries in the calendar from the client module 204 (e.g., time, pickup, drop off address, delivery or not, duration, flexibility, comments, preferences for mobility mode for a certain event, preferred POIs, preferred contacts); send a vehicle mobility icon associated with a calendar event to the mobility server 202 to indicate a mobility mode preference using the vehicle mobility icon; request a mobility plan for a user's calendar events; change a user's preferences; review a user's subsequent ride(s); check client module explanations and notifications; and change events (e.g., edit, delete, and/or create events). The example client module 204 includes a user interface (e.g., a speech, touch/visual, or haptic interface) that allows a user to make any of the foregoing listed requests.

The GUI may include a calendar pane, a map pane, a restart button, and an update button. The calendar pane may be used to input data to the mobility planner system 200 and to show calendar entries uploaded to the client module. The map pane may be used to show delivery and/or transport routes identified by a mobility server. The restart button may be engaged by a user to initiate a restart of a mobility plan calculation. The update button may be engaged by a user to allow for the updating of calendar entries.

The calendar pane may show various calendar events or activities scheduled during the course of a day, the time frame for the activity, and mobility icons indicating the preferred or selected mobility modes for the different activities. For example, a person walking icon may be used to indicate walking as the mobility mode, a delivery truck icon may be used to indicate a delivery service as the mobility mode, a car icon may indicate a private car as a mobility mode, or a specific service provider's icon may indicate that a vehicle from that service provider is the mobility mode.

The calendar pane may use a drop-down menu for data input. For example, for a ride option for an activity, a drop-down menu can be provided that identifies the various mobility mode choices available for the activity. For a delivery option for an activity, a drop-down menu can be provided that identifies whether the activity involves a delivery and if so the starting and ending locations for the delivery. For a time-flexibility option for an activity, a drop-down menu can be provided that allows the user to indicate whether the activity time is flexible.

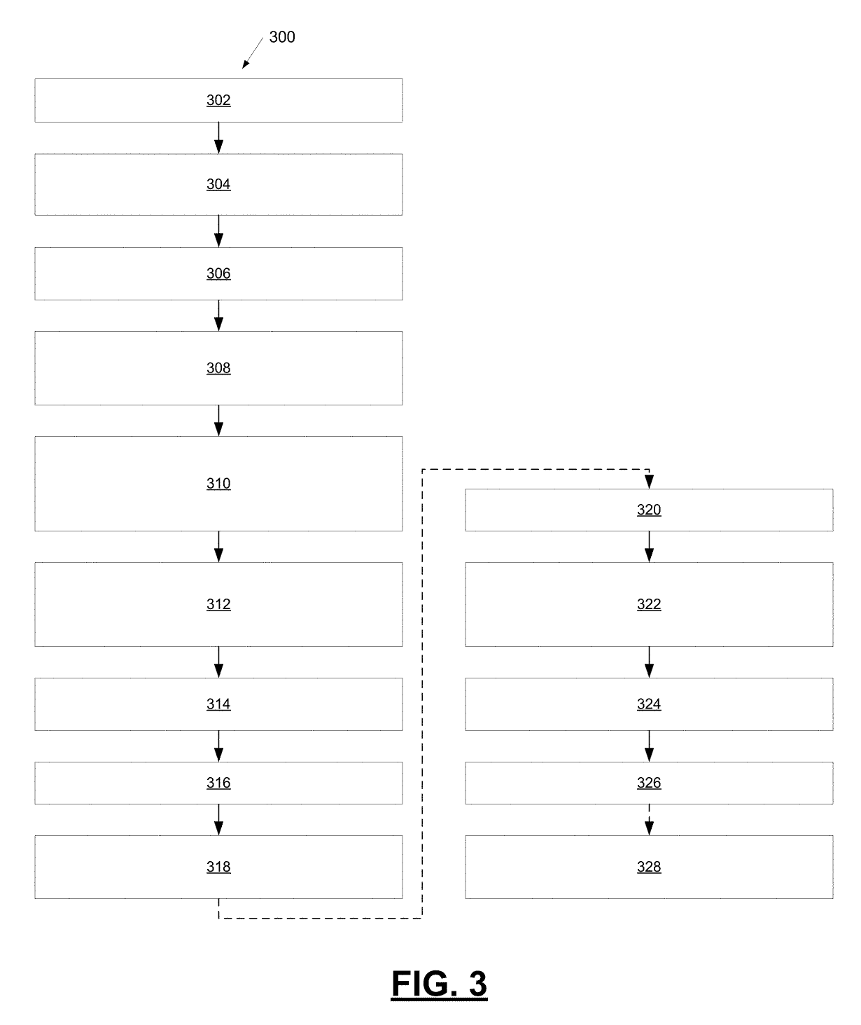

FIG. 3 is a process flow chart depicting an example process 300 in an example mobility planning system for scheduling transportation for users and/or deliveries. The order of operation within the example process 300 is not limited to the sequential execution as illustrated in the figure, but may be performed in one or more varying orders as applicable and in accordance with the present disclosure.

The example process 300 includes receiving a mobility plan request from a user device (operation 302). A request may be received via an electronic message such as an html message or an email message. After receiving the mobility plan request, the user may be identified and the user's user profile may be retrieved, which may include user preferences.

The example process 300 includes receiving a listing of one or more scheduled activities for the user over a predefined period of time (operation 304). The predefined period of time may be specified in the mobility plan request. The predefined period of time may be a portion of a day, a day, or a week. The listing may be retrieved from an application executing on a user device. The listing may be retrieved from a calendar service accessible over a public network (e.g., Google Calendar). The listing may include, for each activity, one or more of the time of the activity, the flexibility of time for the activity, and the duration of the activity. The listing may include, for each activity, a pickup address for the user and a drop off address for the user. The listing may include, for each activity, a preferred mode of mobility or other preferences provided by the user. The listing may, for each activity, identify whether the scheduled activity involves a delivery (goods or a third-party person) or a ride (user ride).

The example process 300 includes creating a listing of the mobility modes potentially available to transport the user to the one or more scheduled activities (operation 306). The potentially available mobility modes may be stored in a database associated with the mobility planning system and retrieved from the database to create the listing. The mobility modes may include one or more of walking, a private car, a rental vehicle (e.g., Avis), a shared car driven by the user (e.g., MAVEN), a shared car not driven by the user (e.g., Lyft, Uber), an autonomous vehicle, a shared autonomous vehicle, an e-bike/bike, a taxi, and public transportation.

The example process 300 includes retrieving the potential availability of the mobility modes provided by the service provider and any service provider indicated constraints regarding the mobility modes (operation 308). The potential availability may be retrieved over a public network from one or more service providers of the mobility modes in real time. The potential availability (e.g., times generally available, specific availability periodically reported, location, and/or geographical area of operation) may be stored in and retrieved from a database. Constraints imposed by a mobility mode service provider may be retrieved in real-time or stored in and retrieved from a database.

The example process 300 includes analyzing the listing of the one or more scheduled activities, the listing of potentially available mobility modes, the potential availability of the mobility modes provided by service providers, and constraints indicated by service provider (operation 310) and preparing a mobility plan for the user based on the analysis, wherein the mobility plan includes the selection of a mobility mode for each activity requiring user transport to the activity (operation 312). The scheduled activity may involve transporting the user to the activity and analyzing may involve calculating a “best” route based on activity requirements and user preferences. The scheduled activity may involve a delivery (goods or a third-party person) in parallel with user activity and analyzing may involve calculating a “best” route for the delivery based on delivery requirements and user preferences. The scheduled activity may involve a delivery (goods or a third-party person) in series with user activity and analyzing may involve calculating a “best” route for the delivery based on delivery requirements, user activity requirements, and user preferences.

The example process 300 includes confirming the availability of mobility modes included in the mobility plan (operation 314). Confirming the availability of mobility modes included in the mobility plan may include sending, for each activity requiring user transport to the activity, a proposed route to a selected mobility mode (or service provider for the selected mobility mode) for confirmation by the selected mobility mode (or service provider) that the selected mobility mode is available for the proposed route. Confirming the availability of mobility modes may further include receiving from a mobility mode (or mobility mode service provider) one or more of availability, location, and time of arrival of the mobility mode. The availability of non-selected mobility modes may be desired (e.g., to facilitate user selection of a different mobility mode) and the example process may include sending, for each activity requiring user transport to the activity, a proposed route to a non-selected mobility mode (or service provider for the non-selected mobility mode).

The example process 300 includes confirming user acceptance of the mobility plan (operation 316). Confirming user acceptance of the mobility plan may include receiving user confirmation of the selected mobility mode (e.g., vehicle or walking). Confirming user acceptance of the mobility plan may include receiving user selection of a non-selected mobility mode and updating the mobility plan to include the user selected mobility mode.

The example process 300 includes scheduling a selected mobility mode for each activity requiring user transport to the activity (operation 318). Scheduling a selected mobility mode may include notifying a mobility mode service provider that a mobility mode is in route to user. In some embodiments, the example process 300 may further include receiving traffic information from the mobility mode (or mobility mode service provider) or from a traffic service provider.

In some embodiments, the example process may further include determining that a route change is needed in the mobility plan (operation 320). Determining that a route change is needed may include receiving a request from the user to change the route. Determining that a route change is needed may include confirming with the user that a route change should be made. A new route for a selected mobility mode may be calculated based on updated information, when it has been determined that a route change is needed (operation 322). The updated information may include traffic information, problem with the mobility mode, time change for activity, or others. The new route may be sent to a selected mobility mode (operation 324). A notification of the new route in the mobility plan may be sent to the user (operation 326).

In some embodiments, the example process may further include determining the best time to inform the user that a selected mobility mode will be available at a specific time at a specific location (operation 328).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A processor-implemented method of mobility planning, the method comprising:
receiving, by a processor in a server over a public network, a listing of one or more scheduled activities over a predefined period of time for each of a plurality of users;
identifying, by the processor, a plurality of different types of mobility modes potentially available to transport the users to the one or more scheduled activities;
analyzing, by the processor, the listing of the one or more scheduled activities, a listing of the potentially available mobility modes, preferences or constraints for one or more of the users, and constraints indicated by one or more service providers;
preparing, by the processor, a mobility plan for each user based on the analysis, the mobility plans including a processor selected mobility mode for each activity requiring user transport to the activity;
confirming, by the processor, the availability of mobility modes included in the mobility plans;
confirming user acceptance of the mobility plans; and
scheduling a selected mobility mode for each activity requiring user transport to the activity.

2. The method of claim 1, wherein the mobility modes comprise one or more of walking, a private car, a rental vehicle, a shared car driven by the user, a shared car not driven by the user, an autonomous vehicle, a shared autonomous vehicle, a bike, a taxi, and public transportation.

3. The method of claim 1, wherein receiving the listing of one or more scheduled activities for a user comprises:
receiving a mobility plan request via a user device;
receiving, from the user device, a listing of one or more scheduled activities spanning a time frame that is consistent with a time frame specified in the plan request;
retrieving, from the listing for each activity requiring user transport or delivery, one or more of the time of the activity, the flexibility of time for the activity, and the duration of the activity;
retrieving, from the listing for each activity requiring user transport or delivery, the pickup address and drop off address; and
retrieving, from the listing for each activity requiring user transport or delivery, the preferred mode of mobility or other preferences if provided in the listing.

4. The method of claim 1, wherein confirming the availability of mobility modes included in the mobility plan comprises sending, for each activity requiring user transport to the activity, a proposed route to a selected mobility mode or service provider for the selected mobility mode.

5. The method of claim 4, further comprising sending, for each activity requiring user transport to the activity, a proposed route to a non-selected mobility mode or service provider for the non-selected mobility mode.

6. The method of claim 1, wherein confirming user acceptance of the mobility plan comprises receiving user confirmation of the selected mobility mode.

7. The method of claim 1, wherein confirming user acceptance of the mobility plan comprises receiving user selection of a non-selected mobility mode and updating the mobility plan to include the user selected mobility mode.

8. The method of claim 1, wherein scheduling a selected mobility mode comprises notifying a mobility mode service provider that a mobility mode is in route to a user.

9. The method of claim 8, further comprising receiving traffic information from a mobility mode service provider or a traffic service provider.

10. The method of claim 1, further comprising receiving from a mobility mode or mobility mode service provider one or more of availability, location, and time of arrival of the mobility mode.

11. A mobility planning server comprising one or more processors configured by programming constructions encoded on non-transient computer readable media, the mobility planning server configured to:
receive, over a public network, a listing of one or more scheduled activities for each of a plurality of users;
identify a plurality of different types of mobility modes potentially available to transport the users to the one or more scheduled activities;
retrieve, over a public network from one or more service providers of the mobility modes, the potential availability of the mobility modes provided by the service provider and any service provider indicated constraints regarding the mobility modes;
analyze the listing of the one or more scheduled activities, a listing of identified mobility modes, the potential availability of the mobility modes provided by service providers, preferences or constraints for one or more of the users, and constraints indicated by one or more service providers;
prepare a mobility plan for each user based on the analysis, the mobility plans including a mobility planning server selected mobility mode for each activity requiring user transport to the activity;
confirm the availability of mobility modes included in the mobility plans;
confirm user acceptance of the mobility plans;
schedule a selected mobility mode for each activity requiring user transport to the activity; and
update, delete, or change a mobility plan when one or more conditions change.

12. The mobility planning server of claim 11, further configured to:
retrieve, from the listing for each activity requiring user transport or delivery, one or more of the time of the activity, the flexibility of time for the activity, and the duration of the activity;
retrieve, from the listing for each activity requiring user transport or delivery, the drop off address;
deduce, for each activity requiring user transport or delivery when a pickup address is not provided in the listing, the pickup address from user location information; and
retrieve, from the listing for each activity requiring user transport or delivery, the preferred mode of mobility or other preferences if provided in the listing.

13. The mobility planning server of claim 11, further configured to receive user selection of a non-selected mobility mode and update the mobility plan to include the user selected mobility mode.

14. A mobility planning system comprising:
a mobility planning server comprising one or more processors configured by programming constructions encoded on non-transient computer readable media, the mobility mapping server configured to:
receive, over a public network, a mobility plan request and a listing of a plurality of scheduled activities for each of a plurality of users, the listing including a plurality of scheduled activities requiring user transport to the activity;
select a mobility mode for each activity requiring user transport to the activity, a plurality of the selected mobility modes being of different types and from different service providers;
prepare a mobility plan for each user that includes the selected mobility modes; and
schedule a selected mobility mode for each activity requiring user transport to the activity; and
a mobility planning client module comprising one or more processors on a user device configured by programming instructions encoded on non-transient computer readable media, the mobility planning client module configured to:
send, over the public network, a mobility plan request and a listing of a plurality of scheduled activities for its user to the mobility planning server; and
receive, over the public network, a prepared mobility plan for its user that includes the selected mobility modes from the mobility planning server.

15. The mobility planning system of claim 14, wherein the mobility planning client module is further configured to upload calendar entries from a calendar application accessible via the user device to the mobility planning client module and wherein the listing of a plurality of scheduled activities for its user the mobility planning client module is configured to send to the mobility planning server comprises the uploaded calendar entries.

16. The mobility planning system of claim 15, wherein the mobility planning client module is further configured to synchronize calendar entries for a predefined time period from the calendar application accessible via the user device with the calendar entries uploaded to the mobility planning client module.

17. The mobility planning system of claim 15, wherein the mobility planning client module is further configured to provide a user interface for allowing the uploaded calendar entries to be edited.

18. The mobility planning system of claim 17, wherein the user interface comprises a graphical user interface that is configured to provide for the use of vehicle mobility icons to indicate a mobility mode preference for a calendar entry activity.

19. The mobility planning system of claim 14, wherein the mobility mapping server is further configured to:
identify a plurality of different types of mobility modes potentially available to transport the user to the one or more scheduled activities;
retrieve, over a public network from one or more service providers of the mobility modes, the potential availability of the mobility modes provided by the service provider and any service provider indicated constraints regarding the mobility modes;
analyze the listing of the one or more scheduled activities, a listing of the identified mobility modes, the potential availability of the mobility modes provided by service providers, and any service provider indicated constraints; and
prepare the mobility plan for the user based on the analysis.

20. The mobility planning system of claim 14, wherein the mobility mapping server is further configured to:
confirm the availability of the mobility modes included in the mobility plan; and
confirm user acceptance of the mobility plan.
